(19) United States
(12) Patent Application Publication
(10) Pub. No.: US 2008/0230735 A1
(43) Pub. Date: Sep. 25, 2008

(54) Control valve body

(75) Inventor: Kuei-Lin Cheng, Lujhu Township (TW)

Correspondence Address: TROXELL LAW OFFICE PLLC, SUITE 1404, 5205 LEESBURG PIKE, FALLS CHURCH, VA, 22041, US

(73) Assignee: BUSINESS ZONE LTD.

(21) Appl. No.: 11/727,196

(22) Filed: Mar. 23, 2007

(51) Int. Cl. F16K 1/42

(52) U.S. Cl. 251/359

(57) ABSTRACT

A control valve body includes a valve seat containing multiple metal pipes and valve chamber; both ends of each pipe being respectively disposed with a water inlet and a water outlet to connect through those chambers; one or a plurality curvature being provided to the pipe between the water inlet and the water outlet; and the valve seat being clad with an outer layer to provide a hard-wearing and production cost saving control valve body construction due to the inherited heat resisting and durable properties of metal pipe.

### BACKGROUND OF THE INVENTION

(a) Field of the Invention

The present invention is related to a control valve body, and more particularly, to one comprised of metal pipe (e.g., copper) clad in an outer layer (e.g., plastic) and molded in a simple process by bending the metal pipe in multiple times to provide a hard-wearing and production cost saving control valve body construction due to the inherited heat resisting and durable properties of metal pipe.

(b) Description of the Prior Art

Conventional control valve body adapted in a mixer of hot water and cold water is usually made of metal by casting. The control valve body is mounted in a tap to achieve regulating water temperature, water volume delivered, and on-off functions by turning the tap. Whereas the control valve body is made using a casting method, water way and valve chamber of a hollow molding cavity needed inside the control valve body are cast by having sand core placed at where the hollow molding cavity is located before pouring the metal liquid. The difficulties involved in locating the sand core during the process affect production speed and rate of conformity; and easy molding of multiple channels to deliver cold water, hot water and mixed water must be provided in the control valve body is prevented when the conventional metal casting method is used. Furthermore, the cast control valve body needs subsequent grinding and polishing processes to consume much more labor, time, and money while resultant metal dust can present serious problem to the environment.

To correct these problems, an improvement titled “PVC Molded Hot & Cold Water Mixer”, No. 284265 published in Taiwan Utility Patents Gazette teaches a manufacturing of a control valve body entirely using an injection molding process. Wherein, hollow plastic components including water supply lines, water inlet and outlet, and valve chamber are molded by injection before being assembled into the control valve body, the control valve body is then placed in a mold to be clad with an out layer also using the injection molding method, and multiple pores are respectively molded at where in symmetric to those parts of the valve chamber, hot and cold water inlets and outlets, and water supply lines that warrant external communication. However, the plastic material is subject to serious heat impacts when both of the hot water and the cold water directly contact the plastic water supply lines. Since the capability of the plastic material to withstand heat impact is weaker thus to compromise the service life of the plastic control valve body. Furthermore, chemicals can be dissolved in hot water to contaminate water quality if higher temperature of hot water is delivered through the water supply line for a longer time.

### SUMMARY OF THE INVENTION

The primary purpose of the present invention is to provide a control valve body comprised of metal pipe (e.g., copper) clad in an outer layer (e.g., plastic) and molded in a simple process by bending the metal pipe in multiple times that is hard-wearing and production cost saving due to the inherited heat resisting and durable properties of metal pipe.

To achieve the purpose, the present invention includes a valve seat containing one or a plurality of metal pipe and one or a plurality of valve chamber; both ends of the metal pipe are respectively disposed with a water inlet and a water outlet; both of the water inlet and the water outlet are connected through the valve chamber; one or a plurality of curvature and the valve seat is clad with an outer layer so to prevent chemicals from being leached to contaminate water quality since hot water delivered contacts the metal pipe, instead of plastic pipe as found with the prior art.

### BRIEF DESCRIPTION OF THE DRAWINGS

FIG. 1 is a schematic view showing a metal pipe is clad with an outer layer in a control valve body of the present invention.

FIG. 2 is a perspective view of the control valve body of the present invention.

FIG. 3 is a perspective view of a construction of multiple metal pipes of the present invention.

FIG. 4 is a perspective view of a construction of the control valve body and an associate control member of the present invention.

FIG. 5 is a schematic view showing a construction of the control valve body of the present invention in a status of the absence of water supply.

FIG. 6 is a schematic view showing a construction of the control valve body of the present invention in a status that cold water is supplied.

FIG. 7 is a schematic view showing a construction of the control valve body of the present invention in a status that both of cold water and hot water are supplied.

FIG. 8 is a schematic view showing another construction of the control valve body of the present invention.

### DETAILED DESCRIPTION OF THE PREFERRED EMBODIMENTS

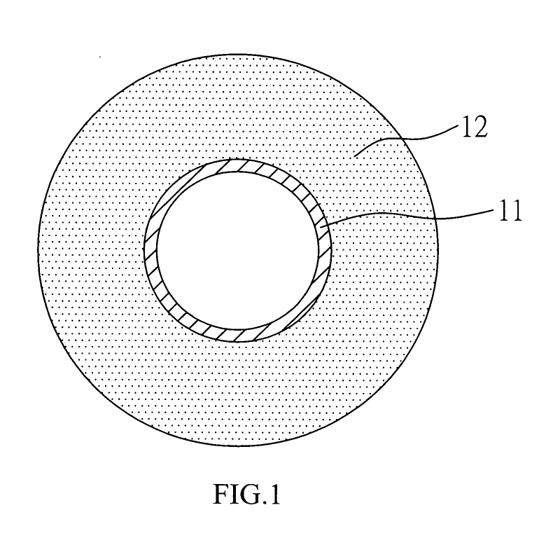

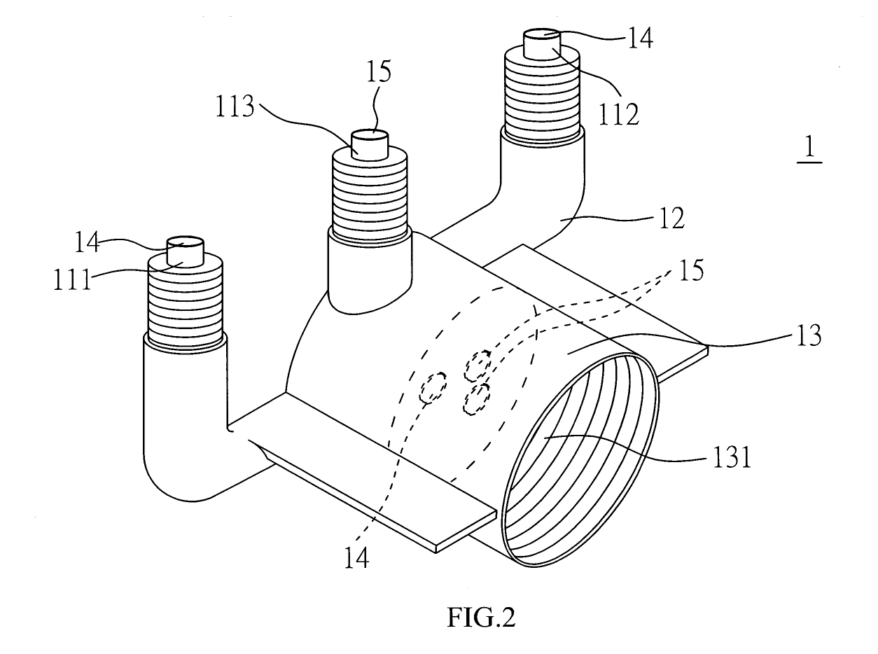

Referring to FIGS. 1 and 2, a control valve body 1 of the present invention includes one or a plurality of metal pipe 11 (e.g., copper) and an outer layer 12 (e.g., plastic material) covering up the metal pipe 11 in a comparatively simple molding process since it takes only a bending process offer a hard-wearing and production cost saving control valve body construction by taking advantage of the inherited heat resisting and durable properties of metal pipe to prevent chemicals from being leached to contaminate water quality since hot water delivered contacts the metal pipe, instead of plastic pipe.

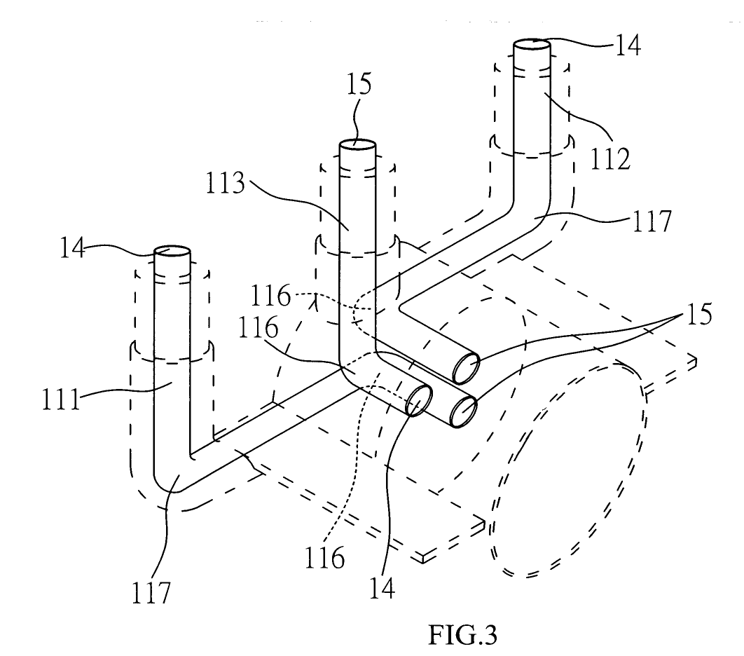

As a preferred embodiment of the present invention illustrated in FIG. 2, the control valve body 1 includes a valve seat 13 contains one or a plurality of metal pipe and one or a plurality of valve chamber 131. The valve seat 13 contains a cold water pipe 111, a hot water metal pipe 112, and a water supply pipe 113. Both ends of each metal pipe are respectively disposed with a water inlet 14 and a water outlet 15. Both water outlets 15 each of the cold/hot water metal pipes 111 and 112, and a water inlet 14 of the water supply metal pipe 113 are connected through the valve chamber 131. As also illustrated in FIG. 3, one curvature 116 is or two curvatures 116, 117 are formed at where between the water inlet 14 and the water outlet 15. The first curvature 116 is provided at where between the water inlet 14 and the water outlet 15 of the water supply metal pipe 113; and both of the first and the second curvatures 116, 117 are disposed between the water inlet 14 and the water outlet 15 of each of both of the cold water and the hot water metal pipes 111, 112.

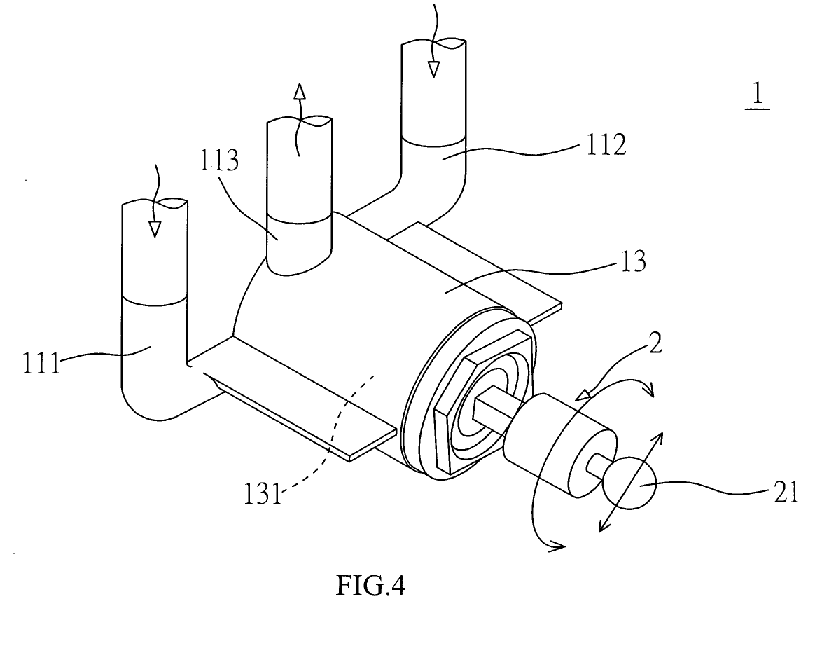

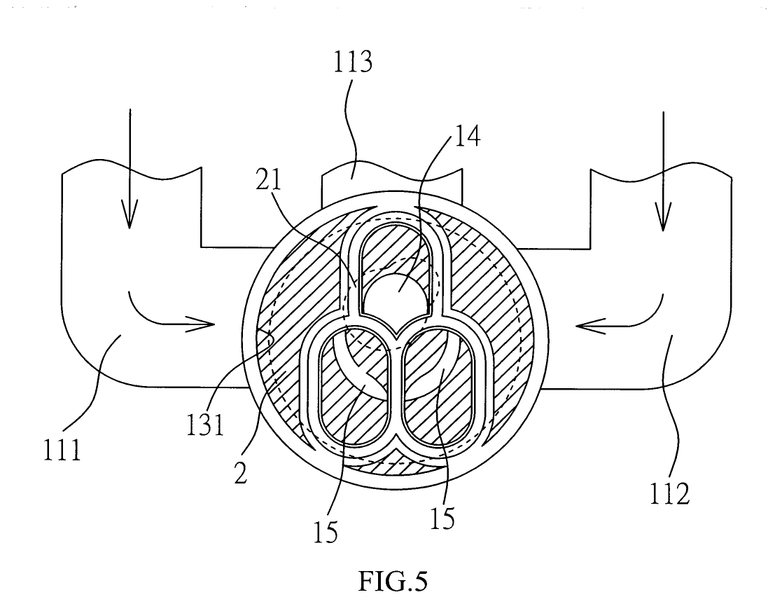

A control member 2 is connected to the valve chamber 131 as illustrated in FIGS. 4 and 5, a valve opening 21 is formed at where the control member 2 extends into the valve chamber 131 and a ball spindle 22 is provided on the other side. Turning the ball spindle 22 controls an area where each water inlet and water outlet are overlapped and the valve opening 21, thus to control flow and temperature of the cold water and hot water respectively flowing from the cold water and the hot water metal pipes 111, 112 into the water supply metal pipe 113.

Now referring to FIG. 5, the valve opening 21 is located at where and overlapped with the water inlet 14 of water supply metal pipe 113 is disposed; and the remainder of the control member 2 screens the water outlet 15 each of the cold water and the hot water metal pipes 111, 112 to prevent both of the cold water and the hot water in their respective metal pipes 111, 112 from entering into the water supply metal pipe 113 through the valve opening 21 in a status of absence of water supply.

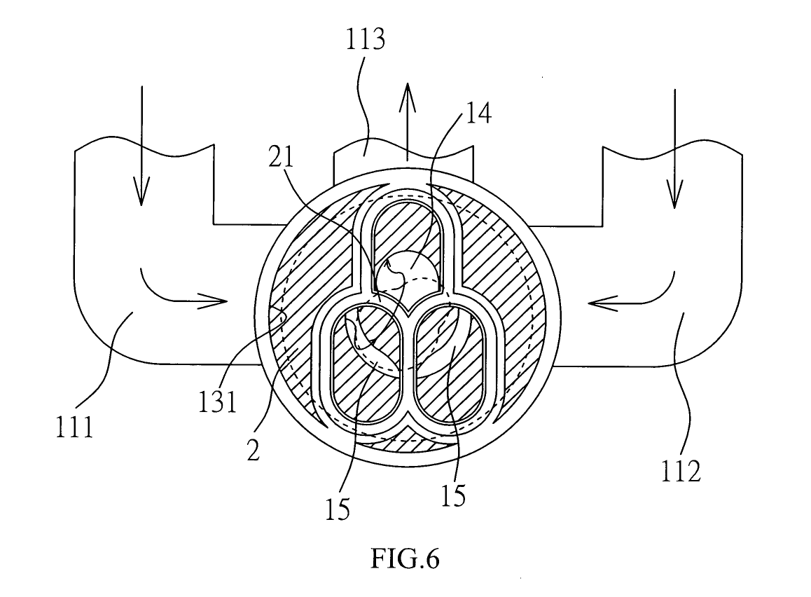

As illustrated in FIG. 6, the valve opening 21 is partially overlapped at the same time with the water outlet 15 of the cold water metal pipe 111 and the water inlet 14 of the water supply metal pipe 113 thus to admit the cold water from the cold water metal pipe 111 flowing through the valve opening 21 into the water supply metal pipe 113 for use.

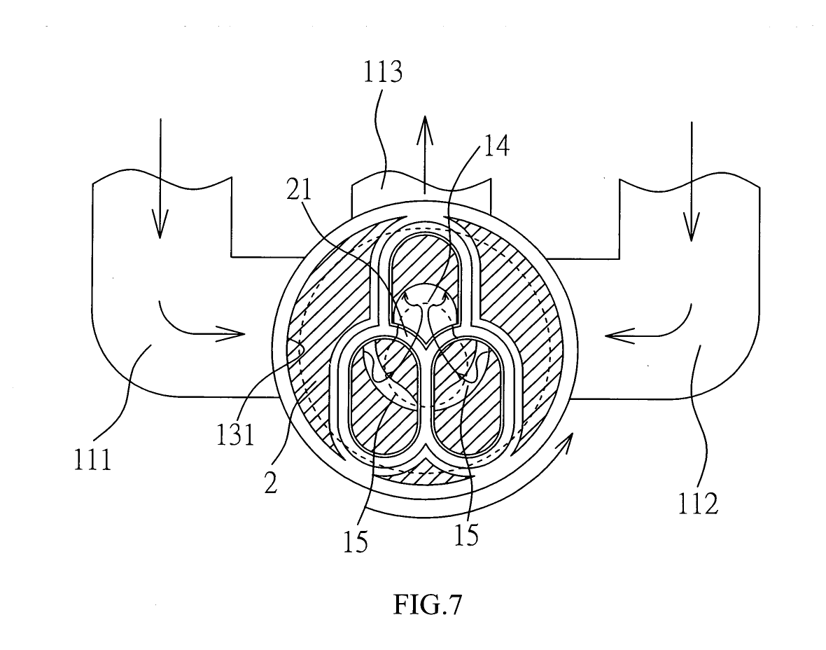

Meanwhile, the valve opening 21 is partially overlapped with both water outlets 15 each of the cold water and hot water metal pipes 111, 112 as well as the water inlet 14 of the water supply metal pipe 113 so to allow both of the cold water and the hot water respectively delivered through the cold water and the hot water metal pipes 111, 112 to enter into the valve chamber where both of the cold water and the hot water are mixed before being delivered through the water supply metal pipe for use as illustrated in FIG. 7.

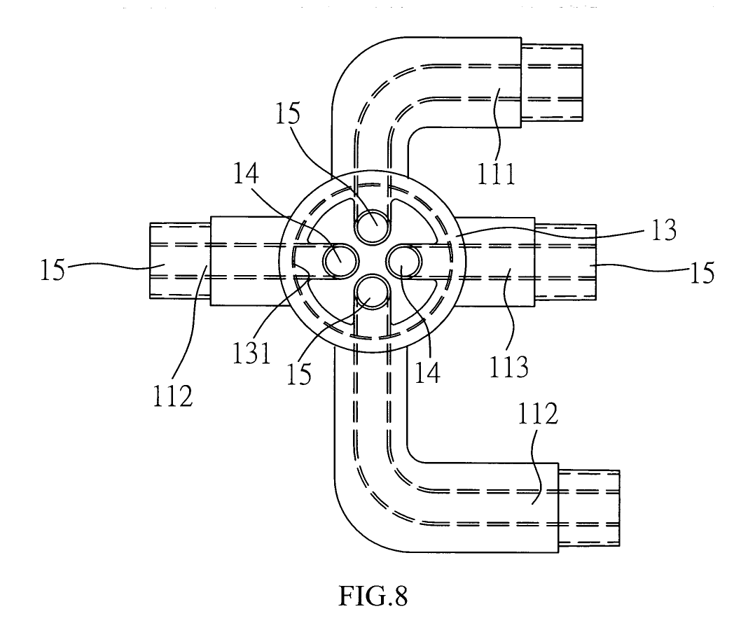

Furthermore, the valve chamber 13 may contain one cold water metal pipe 111, one hot water metal pipe 112, and two water supply metal pipes 113 as illustrated in FIG. 8; wherein, the water inlet 14 and the water outlet 15 connecting through to the valve chamber 131 are respectively disposed at both ends of each metal pipe so to deliver the cold water and the hot water from the cold water metal pipe 111 and the hot water metal pipe 112 respectively through those two water supply metal pipes 113 for use.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A control valve body includes a valve seat containing one or a plurality of metal pipe and one or a plurality of valve chamber; both ends of the metal pipe being respectively disposed with a water inlet and a water outlet; both of the water inlet and the water outlet connecting through the valve chamber; one or a plurality of curvature being disposed at where between the water inlet and the water outlet; and an outer layer covering up the valve seat.

2. The control valve body as claimed in claim 1, wherein the valve seat contains a cold water pipe, a hot water pipe, and a water supply metal pipe.

3. The control valve body as claimed in claim 1, wherein the valve seat contains a cold water pipe, a hot water pipe, and two water supply metal pipes.

4. The control valve body as claimed in claim 1, wherein a control member is connected to the valve chamber.

5. The control valve body as claimed in claim 4, wherein a valve opening is formed at where the control member extends into the valve chamber and a ball spindle is disposed on the other side.

6. The control valve body as claimed in claim 1, wherein the metal pipe is made of copper.

7. The control valve body as claimed in claim 1, wherein the outer layer is made of plastic material.

8. A control valve body includes one or a plurality of metal pipe; both ends of each metal pipe being respectively disposed with a water inlet and a water outlet; and an outer layer covering up the metal pipe.

9. The control valve body as claimed in claim 8, wherein one curvature is disposed at where between the water inlet and the water outlet.

10. The control valve body as claimed in claim 8, wherein multiple curvatures are disposed at where between the water inlet and the water outlet.
